(19) United States
(12) Patent Application Publication
(10) Pub. No.: US 2018/0324261 A1
(43) Pub. Date: Nov. 8, 2018

(54) METHOD OF NETWORK SERVICE DESCRIPTOR MANAGEMENT IN A NETWORK FUNCTIONS VIRTUALIZATION

(71) Applicant: Electronics and Telecommunications Research Institute, Daejeon (KR)

(72) Inventors: Jong Hwa Yi, Daejeon (KR); Myung Ki Shin, Seoul (KR)

(73) Assignee: Electronics and Telecommunications Research Institute, Daejeon (KR)

(21) Appl. No.: 15/974,051

(22) Filed: May 8, 2018

(30) Foreign Application Priority Data
May 8, 2017 (KR) 10-2017-0057501
Apr. 4, 2018 (KR) 10-2018-0039021

(51) Int. Cl. H04L 29/08

(52) U.S. Cl. CPC H04L 67/16; H04L 67/02

(57) ABSTRACT

Provided is a Network Service (NS) descriptor management method performed by a Network Functions Virtualization Orchestrator (NFVO), the method including receiving a request message for a Hypertext Transfer Protocol (HTTP) method for a NS descriptor from an Operation Support System/Business Support System (OSS/BSS); and responding to the OSS/BSS with respect to the received request message. If the HTTP method for the NS descriptor is POST, a new NS descriptor is created, and if the HTTP method for the NS descriptor is GET, query information about a plurality of network descriptors is processed.

### CROSS-REFERENCE TO RELATED APPLICATION(S)

This application claims the priority benefit of Korean Patent Application Nos. 10-2017-0057501 filed on May 8, 2017 and 10-2018-0039021 filed on Apr. 4, 2018 in the Korean Intellectual Property Office, the disclosure of which is incorporated herein by reference for all purposes.

### BACKGROUND

### 1. Field

One or more example embodiments relate to a Network Service (NS) descriptor management method in a Network Functions Virtualization (NFV) environment, and more particularly, to an NS descriptor management method between an Operation Support System/Business Support System (OSS/BSS) and a Network Functions Virtualization Orchestrator (NFVO).

### 2. Description of Related Art

Due to cost saving of communication providers and virtualization, there is a need for a Network Functions Virtualization (NFV) technology that may flexibly support network services and avoid vender dependency. In terms of supporting network services based on NFV, NFV architectures, interfaces, and protocols need to be developed.

### SUMMARY

At least one example embodiment provides a Network Service (NS) descriptor management method in an interface of an Os-Ma-nfvo reference point between an Operation Support System/Business Support System (OSS/BSS) and a Network Functions Virtualization Orchestrator (NFVO).

At least one example embodiment also provides a procedure associated with registering, searching for, executing, modifying, deleting, and updating a Network Service (NS) identifier.

According to an aspect, there is provided a Network Service (NS) descriptor management method performed by a Network Functions Virtualization Orchestrator (NFVO), the method including receiving a request message for a Hypertext Transfer Protocol (HTTP) method for an NS descriptor from an Operation Support System/Business Support System (OSS/BSS); and responding to the OSS/BSS with respect to the received request message. If the HTTP method for the NS descriptor is POST, a new NS descriptor is created. If the HTTP method for the NS descriptor is GET, query information about a plurality of network descriptors is processed.

In the created NS descriptor, NSDOperationalState may be set as “DISABLED”, NSDUsageState may be set as “NOT_IN_USE”, and NSDOnboardingState may be set as “CREATED”.

According to an aspect, there is provided a method of managing each NS descriptor, performed by an NFVO, the method including receiving a request message for an HTTP method for each NS descriptor from an OSS/BSS; and responding to the OSS/BSS with respect to the received request message. If the HTTP method for each NS descriptor is GET, information about each NS descriptor is read. If the HTTP method for each NS descriptor is PATCH, information about each network descriptor is modified. If the HTTP method for each NS descriptor is DELETE, each NS descriptor is deleted.

In the created NS descriptor, NSDOperationalState may be set as “DISABLED”, NSDUsageState may be set as “NOT_IN_USE”, and NSDOnboardingState may be set as “CREATED”.

According to an aspect, there is provided a NS descriptor management method performed by an NFVO, the method including receiving a request message for an HTTP method for Network Service Descriptor (NSD) content from an OSS/BSS; and responding to the OSS/BSS with respect to the received request message. If the HTTP method for the NSD content is GET, the NSD content is fetched. If the HTTP method for the NSD content is PUT, the NSD content is uploaded.

The NS descriptor may have been created and the NSD content may be on-boarded to the NFVO.

According to an aspect, there is provided an NS descriptor management method performed by an NFVO, the method including receiving a request message for an HTTP method for subscriptions from an OSS/BSS; and responding to the OSS/BSS with respect to the received request message. If the HTTP method for the subscriptions is POST, change notifications of the NS descriptor are subscribed. If the HTTP method for the subscriptions is GET, the subscriptions are queried.

The subscription may include a data structure of “NsdmSubscriptionRequest” in a payload.

According to an aspect, there is provided an NS descriptor management method performed by an NFVO, the method including receiving a POST request message from an OSS/BSS; creating an NS descriptor in response to the received POST request message; and sending, to the OSS/BSS, a response message (Created response message) indicating that the NS descriptor is created.

In the created NS descriptor, NSDOperationalState may be set as “DISABLED”, NSDUsageState may be set as “NOT_IN_USE”, and NSDOnboardingState may be set as “CREATED”.

The POST request message may include a data structure of “CreateNsdInfoRequest” in a payload.

According to an aspect, there is provided an NS descriptor management method performed by an NFVO, the method including receiving a DELETE request message from an OSS/BSS for deleting each NS descriptor; deleting each NS descriptor in response to the received DELETE request message; and sending, to the OSS/BSS, a response message (No Content response) indicating an empty payload.

The NS descriptor management method may further include sending, to the OSS/BSS, an NsdDeletionNotification message indicating that each NS descriptor is deleted.

The response message (No Content response) and the NsdDeletionNotification message may be sent to the OSS/BSS in random order.

According to an aspect, there is provided an NS descriptor management method performed by an NFVO, the method including receiving a PATCH request message from an OSS/BSS to change NSDOperationalState of each NS descriptor; changing the NSDOperationalState of the NS descriptor from “DISABLE” to “ENABLE” in response to the received PATCH request message; and sending a response message (OK response) to the OSS/BSS.

The NS descriptor management method may further include sending, to the OSS/BSS, an NsdChangeNotification message indicating that the NSDOperationalState is “ENABLE” and the NSDOperationalState of each NS descriptor is changed.

According to an aspect, there is provided an NS descriptor management method performed by an NFVO, the method including receiving a PATCH request message from an OSS/BSS to change NSDOperationalState of each NS descriptor; changing the NSDOperationalState of the NS descriptor from “ENABLE” to “DISABLE” in response to the received PATCH request message; and sending a response message (OK response) to the OSS/BSS.

The NS descriptor management method may further include sending, to the OSS/BSS, an NsdChangeNotification message indicating that the NSDOperationalState is “DISABLE” and the NSDOperationalState of each NS descriptor is changed.

According to an aspect, there is provided an NS descriptor management method performed by an NFVO, the method including receiving a PATCH request message from an OSS/BSS to update each NS descriptor; modifying information about the NS descriptor in response to the received PATCH request message; and sending, to the OSS/BSS, a response message (OK response) including a data structure of “nsdInfoModification”.

The NS descriptor management method may further include updating NS descriptor information by sending, to the OSS/BSS, an NsdChangeNotification message indicating that information of each NS descriptor is modified.

According to some example embodiments, there is provided an NS descriptor management method in an interface of an Os-Ma-nfvo reference point between an OSS/BSS and an NFVO.

According to some example embodiments, there is provided a procedure associated with registering, searching for, executing, modifying, deleting, and updating an NS identifier.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates a Network Functions Virtualization (NFV)-Management and Orchestration (MANO) architectural framework having a reference point according to an example embodiment;

FIG. 2 illustrates a transition of a Network Service Descriptor (NSD) state model according to an example embodiment;

FIG. 3 illustrates a resource Uniform Resource Identifier (URI) structure of an NSD management interface according to an example embodiment;

FIG. 4 illustrates a procedure of creating each NS descriptor according to an example embodiment;

FIG. 5 illustrates a procedure of uploading NSD content according to an example embodiment;

FIG. 6 illustrates a procedure of fetching on-boarded NSD content according to an example embodiment;

FIG. 7 illustrates a procedure of updating each NS descriptor according to an example embodiment;

FIG. 8 illustrates a procedure of deleting each NS descriptor according to an example embodiment;

FIG. 9 illustrates a procedure of reading information of each NS descriptor and querying information about a plurality of NS descriptors according to an example embodiment;

FIG. 10 is a diagram illustrating a module included in a Network Functions Virtualization Orchestrator (NFVO) for supporting NSD management according to an example embodiment;

FIG. 11 is a flowchart illustrating a process of processing an NSD management module in an NFVO according to an example embodiment;

FIG. 12 is a flowchart illustrating a process of performing an NSD creation in an NFVO according to an example embodiment;

FIG. 13 is a flowchart illustrating a process of performing an NSD deletion in an NFVO according to an example embodiment;

FIG. 14 is a flowchart illustrating a process of performing NSD update in an NFVO according to an example embodiment;

FIG. 15 is a flowchart illustrating a process of performing an NSD query in an NFVO according to an example embodiment; and

FIG. 16 is a flowchart illustrating a process of performing an NSD subscription/notification in an NFVO according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the example embodiments are described with reference to the accompanying drawings. For the purposes of the present specification, the following abbreviations apply:

<Abbreviations>

API: Application Programming Interface

BSS: Business Support System

CP: Connection Point

CPD: CP Descriptor

DF: Deployment Flavor

ET SI: European Telecommunications Standards Institute

FM: Fault Management

GS: Group Specification

GUI: Graphical User Interface

HTTPS: HTTP Secure

JSON: JavaScript Object Notation

LCCN: Lifecycle Change Notification

LCM: Lifecycle Management

NFP: Network Forwarding Path

NFPD: NFP Descriptor

NFV: Network Functions Virtualization

NFVI: Network Function Virtualization Infrastructure

NFVO: NFV Orchestrator

NS: Network Service

NSD: Network Service Descriptor

OSS: Operation Support System

PNF: Physical Network Function

PNFD: Physical Network Function Descriptor

TLS: Transport Layer Security

UDP: User Datagram Protocol

URI: Uniform Resource Identifier

VDU: Virtualization Deployment Unit

VIM: Virtualized Infrastructure Manager

VNF: Virtualized Network Function

VNFC: VNF Component

VNFD: VNF Descriptor

VNFFG: VNF Forwarding Graph

VNFFGD: VNFFG Descriptor

VNFM: VNF Manager

<Relation of NFV Management and Orchestration (MANO) with Existing Management and Orchestration Systems>

According to an example embodiment, NFV-MANO functions may play an important role in delivering business benefits. The business benefits may be achieved through interworking with other functional components in an NFV framework, as well as external entities, such as Operation Support System/Business Support System (OSS/BSS).

<NFV-MANO Interworking with OSS/BSS>

The NFV-MANO alone may not deliver the NFV business benefits and may need to integrate and interwork with other management entities to deliver the business benefits using interfaces between the NFV-MANO and other management entities, for example, the OSS/BSS.

For service providers to achieve the full benefits of NAV, NFV-MANO solutions may need to be considered holistically alongside OSS/BSS integration and management requirements. Simply extending existing OSS/BSS models may not be sufficient because this approach will not support value-added capabilities and services by NFV.

According to an example embodiment, there is a need to ensure that NFV-MANO and OSS/BSS evolution is coordinated to jointly support the following:
Open and consistent interfaces, to facilitate automation, self-service operations at service and product level that may respond with a speed and agility required by changing business needs.
Adaptive automation where a service usage may drive on-demand resource requirements, triggering feedback from the system that the management functions analyze and make changes to, enabling the infrastructure to provide resources and services needed at a corresponding point in time.
Orchestration where policies (and other mechanisms) may guide a decision required to change all or a portion of the system to perform a given function.
Personalized services that are generally configured by an operator and/or end-user at the service and/or network resource layers, to fit individual customer preferences and requirements.
Technology-driven innovation where rapid development, continuous integration, deployment, and experimentation may meet business and service operations agility and enable the migration to next generation operations.

<Overview of Management and Orchestration Architectural Framework>

The NFV-MANO architectural framework focuses on aspects that are provided to networks of the operator by NFV and thus, mainly focuses on new functional blocks and reference points between the corresponding functional blocks. Other functional blocks and reference points that may be necessary for a better understanding of the NFV-MANO architectural framework may be included.

<Principles of NFV-MANO>

The NFV-MANO architectural framework relies on a set of principles that support a combination of concepts of distant Administrative Domains and layered management and orchestration functionality in each of the domains:
The NFV-MANO architecture needs to include a possibility of multiple NFV-MNO functional blocks in Tenant Domain leveraging resources in the same Infrastructure Domain. There may be a general architectural principle of horizontal equality between the NFV-MANO functional blocks.
Orchestration is provided in multiple functional blocks and it is important to emphasize that there is no functional block having primacy over other functional blocks. There may be a general architectural principle of equality used in distribution of orchestration functionality.
The NFV-MANO functional blocks in the Infrastructure Domain may provide abstracted services to functional blocks in the Tenant Domain. The aspects of resource management corresponding to the abstracted services may be fully included as a selectable resource policy.
It may be possible to leverage best cloud management practices such as assignment of resources according to the availability of abstracted services provided from the Infrastructure Domain to the Tenant Domain.
The NFV-MNO functionality may be realized in different ways, for example, as a monolithic single instance, as a scalable system with multiple load-sharing instances, as a system of distributed cooperating instances, or as a functionally decomposed and distributed system. The NFV-MNO functionality may be realized as extension of a cloud/network management system or as a separate system interacting with the cloud/network management system to realize the NFV.

Herein, any specific realization of the NFV-MANO architectural framework is not required and, instead, it recommends that the following best practices are leveraged and the NFV-MANO architectural framework may:
lend the NFV-MANO architectural framework to virtualization and be implemented in software only;
lend the NFV-MANO architectural framework to possible distribution and scaling across the NFVI to improve service availability and support different locations;
lend the NFV-MANO architectural framework to full automation (ability to react to events in real time without human intervention, and execute actions associated with the events, based on pre-provisioned templates and policies);
lend the NFV-MANO architectural framework to implementations that do not contain any single points of failures with the potential to endanger service continuity;
lend the NFV-MANO architectural framework to an implementation with an open architectural approach and may expose standard or “de-facto” standard interfaces;
support and help realize the feasible decoupling of VNF software from hardware;
support management and orchestration of VNFs and Network Services using NFVI resources from a single or across multiple NFVI-PoPs;
support modelling of NFVI resource requirements of VNFs in an abstracted way; and
support modelling of NFVI resources in a way that an abstraction of the NFVI resources may be exposed by functionality in a single layer to functionality in a different layer.

<NFV-MANO Architectural Framework Overview>

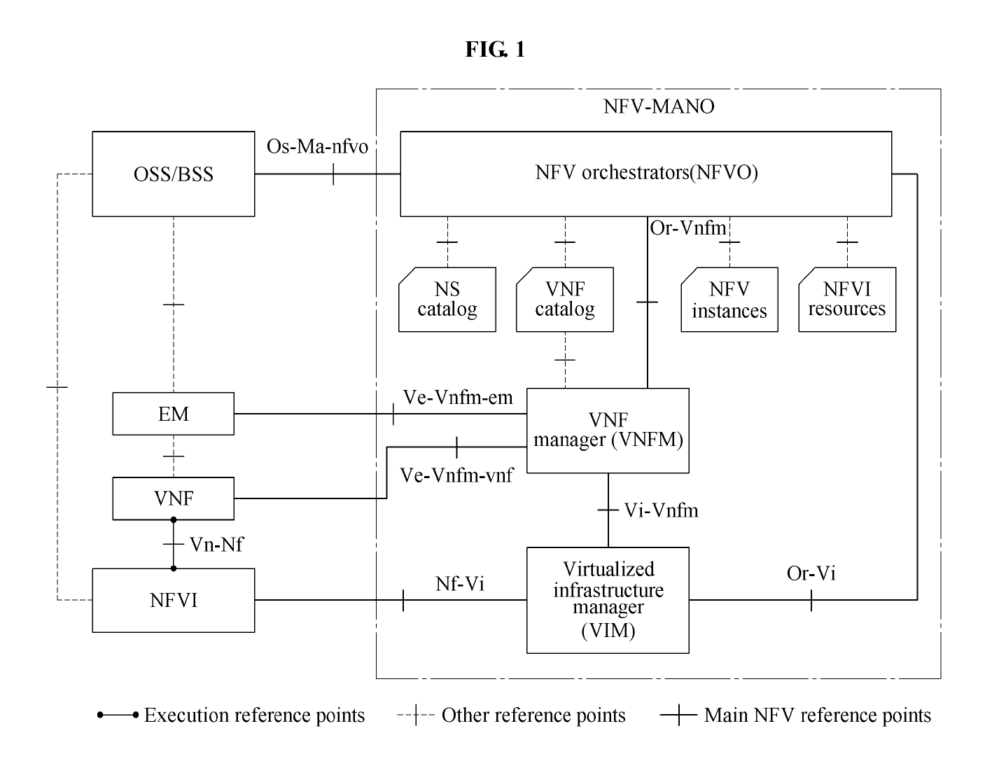

FIG. 1 illustrates an NFV-MANO architectural framework having a reference point according to an example embodiment. The following entities from the NFV architectural framework are considered within the scope of the NFV-MANO architectural framework:

a) Functional blocks that are identified to belong to the NFV MANO;

b) Other functional blocks that interact with the NFV-MANO via reference points; and

c) All reference points that enable communication to, from, and within the NFV-MANO.

The NFV-MANO architectural framework follows the following principles. Each of the functional blocks has a well-defined set of responsibilities and operates on well-defined entities using management and orchestration as applicable within a functional block as well as leveraging services provided from other functional blocks.

The NFV-MANO architectural framework identifies the following NFV-MANO functional blocks:
Virtualized Infrastructure Manager (VIM)
NFV Orchestrator (NFVO)
VNF Manager (VNFM)

The NFV-MANO architectural framework identifies the following data repositories:
NS Catalog
VNF Catalog
NFV Instances repository
NFVI Resources repository

The NFV-MANO architectural framework identifies the following functional blocks that share reference points with the NFV-MANO:
Element Management (EM)
Virtualized Network Function (VNF)
OSS/BSS
NFV Infrastructure (NFVI)

The NFV-MANO architectural framework identifies the following main reference points:
Os-Ma-nfvo, a reference point between OSS/BSS and NFVO
Ve-Vnfm-em, a reference point between EM and VNFM
Ve-Vnfm-vnf, a reference point between VNF and VNFM
Nf-Vi, a reference point between NFVI and VIM
Or-Vnfm, a reference point between NFVO and VNFM
Or-Vi, a reference point between NFVO and VIM
Vi-Vnfm, a reference point between VIM and VNFM

<NFV Orchestrator (NFVO)>

The NFVO has the following two main responsibilities:
the orchestration of NFVI resources across multiple VIMs, fulfilling the Resource Orchestration functions; and
the lifecycle management of Network Services, fulfilling the Network Service Orchestration functions.

The following list expresses a non-exhaustive set of capabilities that are provided from the NFVO through the Network Service Orchestration functions. The capabilities may be exposed through interfaces used by NFV-MANO functional blocks or by authorized external entities.
The management of Network Services templates and VNF Packages (e.g., on-boarding new Network Services and VNF Packages). During on-boarding of NS and VNF, a validation step is required. To support subsequent instantiation of NS and VNF, the validation procedure needs to verify the integrity and authenticity of the provided deployment template and that all mandatory information is present and consistent.
Network Service instantiation and Network Service instance lifecycle management, for example, update, query, scaling, collecting performance measurement results, event collection and correlation, and termination.
Management of the instantiation of VNF Managers where applicable.
Management of the instantiation of VNFs in coordination with VNF Managers.
Validation and authorization of NFVI resource requests from the VNF Managers that may affect Network Services (granting of the requested operation needs to be governed by policies).
Management of integrity and visibility of Network Service instances through their lifecycle, and the relationship between the Network Service instances and the VNF instances using the NFV Instances repository.
Management of the Network Service instances topology (e.g., create, update, query, and delete VNF Forwarding Graphs)
Network Service instances automation management (e.g., trigger the automatic operational management of NS instances and VNF instances, according to triggers and actions that are captured in the on-barcoded NS and VNF deployment templates and governed by policies applicable to the NS instances and the VNF instances).
Policy management and evaluation for the Network Service instances and the VNF instances (e.g., policies related to affinity/anti-affinity, scaling, fault and performance, geography, regulatory rules, NS topology, etc.)

The NFVO uses the Resource Orchestration functionality to provide services that support accessing NFVI resources in an abstracted manner independently of any VIMs as well as governance of VNF instances sharing resources of the NFVI infrastructure.

The following list expresses a non-exhaustive set of functionalities performed by the Resource Orchestration function. The functionalities may be exposed through interfaces and used by NFV-MANO functional blocks or authorized external entities:
Validation and authorization of NFVI resource requests from the VNF Manager(s) that may affect the way of allocating the requested resources within a single NFVI-PoP or multiple NFVI-PoPs (granting of the requested resources is governed by polices, and may require prior reservation).
NFVI resource management across Infrastructure Domains of the operator including distribution, reservation, and allocation of NFVI resources to Network Service Instances and VNF instances using the NFVI resources repository, as well as locating and/accessing one or more VIMs as needed and providing the location of an appropriate VIM to the VNFM if necessary.
Supporting the management of relationship between the VNF instances and the NFVI resources allocated to the VNF instances using the NFVI Resources repository and information received from the VIMs.
Policy management and enforcement for the Network Service instances and the VNF instances (e.g., NFVI resources access control, reservation, and/or allocation polices, placement optimization based on affinity and/or anti-affinity rules as well as geography and/or regulatory rules, resource usage, etc.).
Collecting usage information of NFVI resources by the VNF instances or groups of the VNF instances, for example, by collecting information about the quantity of NFVI resources consumed through NFVI interfaces and then correlating NFVI usage records to the VNF instances.

<OSS/BSS>

The OSS/BSS are the combination of other operations of the operator and business support functions that are not explicitly captured in the present architectural framework, but are expected to have information exchanges with functional blocks in the NFV-MANO architectural framework. OSS/BSS functions may provide management and orchestration of legacy systems and may have the full end-to-end visibility of services provided by legacy network functions in a network of the operator.

<NFV-MANO Reference Point Os-Ma-Nfvo>

The reference point Os-Ma-nfvo is used for messages exchanged between the OSS/BSS and the NFVO and supports the following:
Network Service Descriptor and VNF package management
Network Service instance lifecycle management:
   Network Service instantiation;
   Network Service instance update (e.g., update a VNF instant that is included in the Network Service instance);
   Network Service instance query (e.g., retrieve summarized information about NFVI resources associated with the Network Service instance or a VNF instance within the Network Service instance);
   Network Service instance scaling; and
   Network Service instance termination.
VNF lifecycle management:
   For VNF lifecycle management, the NFV Orchestrator identifies the VNF Manager and forwards a request.
Policy management and/or enforcement for Network Service instances, VNF instances, and NFVI resources (for authorization/access control, resource reservation/placement/allocation, etc.)
Querying a relevant Network Service instance and VNF instance information from the OSS/BSS
Forwarding of events, accounting and usage records and performance measurement results regarding Network Service instances, VNF instances, and NFVI resources to the OSS/BSS, as well as, and information (e.g., a number of VMs used by a specific VNF instance) about associations between the instances and the NFVI resources.

<NFV-MANO Reference Point Or-Vnfm>

The reference point Or-Vnfm is used for information exchanged between the NFVO and the VNF Manager, and supports the following:
NFVI resources authorization/validation/reservation/release for a VNF
NFVI resources allocation/release request for a VNF
VNF instantiation
VNF instance query (e.g., retrieve any runtime information)
VNF instance update (e.g., update configuration)
VNF instance scaling out/in and scaling up/down
VNF instance termination
VNF package query
Forwarding of events, other state information about the VNF that may affect the Network Service instance.

<NFV-MANO Reference Point Or-Vi>

The reference point Or-Vi is used for information exchanged between the NFVO and the VIM and supports the following:
NFVI resource reservation/release
NFVI resource allocation/release/update
VNF software image addition/deletion/update
Forwarding of configuration information, events, measurement results, and usage records regarding the NFVI resources to the NFVO.

<Network Service Descriptor (NSD)>

The NSD includes the following static information elements and is used by the NFVO to instantiate a Network Service including one or more VNF Forwarding Graphs, VNFs, PNFs, and VLs. The NSD describes deployment flavors of Network Service.

Table 1 shows NSD base elements.

TABLE 1

| Identifier | Type | Cardinality | Description |
|---|---|---|---|
| Id | Leaf | 1 | ID of Network Service Descriptor |
| vendor | Leaf | 1 | Provider or vendor of Network Service |
| version | Leaf | 1 | Version of NS descriptor |
| vnfd | Reference | 1~N | VNF that is a part of the Network Service. |
| | | | This element is required, for example, when |
| | | | the Network Service is being built top-down |
| | | | or when instantiating VNFs as well. |
| vnffgd | Reference | 0~N | VNFFG that is a part of the Network Service. |
| | | | The Network Service may have multiple |
| | | | graphs, for example, for: |
| | | | 1. Control plane traffic |
| | | | 2. Management-plane traffic |
| | | | 3. User plane traffic itself may have multiple |
| | | | NFPs based on QoS, etc. The traffic is |
| | | | adjusted amongst 1 of the NFPs based on |
| | | | policy decisions. |
| vld | Reference | 0~N | Virtual link that is a part of the Network |
| | | | Service. |
| lifecycle_event | Leaf | 0~N | Defines NS functional scripts/workflows for |
| | | | specific lifecycle events (e.g., initialization, |
| | | | termination, scaling). |
| vnf_dependency | Leaf | 0~N | Describes dependency between VNFs. |
| | | | Defined in terms of source and target VNFs |
| | | | (i.e., the target VNF depends on the source |
| | | | VNF). That is, the source VNF needs to |
| | | | exist and connect to the service before the |
| | | | target VNF is initiated/deployed/connected. |
| | | | For example, this element may be used to |
| | | | define a sequence in which various network |
| | | | nodes and links within a VNF FG need to be |
| | | | instantiated by the NFVO. |
| monitoring_parameter | Leaf | 0~N | Represents a monitoring parameter capable of |
| | | | being tracked for the NS, and may be a |
| | | | network service metric that is tracked to meet |
| | | | the network service availability contributing |
| | | | SLAs (e.g., NS downtime). |
| | | | Also, it may be used to specify different |
| | | | deployment flavors for the Network Service |
| | | | in NS descriptor and/or to indicate different |
| | | | levels of network service availability, for |
| | | | example, specific parameters, such as |
| | | | calls-per-second (CPS), |
| | | | number-of-subscribers, no-of-rules, |
| | | | flows-per-second, etc. |
| | | | One or more of the parameters may have |
| | | | influence in determining the need to |
| | | | scale-out. |
| service_deployment_flavor | Element | 1~N | Represents service KPI parameters and |
| | | | requirements for each deployment flavor of |
| | | | the NS being described. For example, there |
| | | | may be a deployment flavor that describes |
| | | | requirements to support a vEPC with 300k |
| | | | calls per second. Also, there may be another |
| | | | deployment flavor that describes the |
| | | | requirements to support vEPC with 500k calls |
| | | | per second. |
| auto_scale_policy | Leaf | 0~N | Represents policy metadata that may include |
| | | | criteria parameter and action-type. The |
| | | | criteria parameter may be a supported |
| | | | assurance parameter. |
| connection_point | Element | 1~N | This element describes a Connection Point |
| | | | that acts as an endpoint of the Network |
| | | | Service and may, for example, be referenced |
| | | | by other elements as an endpoint. |
| pnfd | Reference | 0~N | PNFs that are part of Network Service. |
| nsd_security | Leaf | 0~1 | This is a signature of NSD to prevent |
| | | | tampering. A specific hash algorithm used |
| | | | to calculate the signature is included with a |
| | | | corresponding cryptographic certificate to |
| | | | validate the signature. |

<Network Service Descriptor Management>

The reference point Os-Ma-nfvo is applied between the NFVO and the OSS/BSS and created by the NFVO and used by the OSS/BSS.

When the operation is an On-board Network Service Descriptor, this operation allows submitting and validating a Network Service Descriptor (NSD), including any related VNFFGD and VLD. If the operation is successfully completed, the NSD is stored in an NS catalog and used for Network Service (NS) lifecycle management.

When the operation is a Disable Network Service Descriptor, this operation allows disabling a Network Service Descriptor so that the NSD may not be instantiated any further. If the operation is successfully completed, the NSD is disabled in the NS catalog and has no effect on NS instances previously created using the NSD.

When the operation is an Enable Network Service descriptor, this operation allows enabling a Network Service Descriptor. If the operation is successfully completed, the NSD is enabled in the NS catalog and has no effect on the NS instances previous created using the NSD.

When the operation is an Update Network Service Descriptor, this operation allows updating a Network Service Descriptor, including any related VNFVVGD and VLD. This update may include creating/deleting new VNFFGDs and/or new VLDs. If the operation is successfully completed, the NSD is updated in the NS catalog and has no effect on the NS instances previously created using the original NSD.

When the operation is a Query Network Service Descriptor, this operation is used to query information of the Network Service Descriptor, including any related VNFFVGD and VLD. This operation allows retrieving information from the NSD, VNFFGDs, and VLDs, for example, NSD version, a list of participating VNFs, service deployment flavor, auto scale policy, etc.

When the operation is a Delete Network Service Descriptor, this operation is used to remove a disabled Network Service Descriptor.

<On-Board NSD Operation>

1. Description

The on-board NSD operation may on-board an NSD in the NFVO. Here, associated descriptors, VLD and VNFFGD, that are part of the NSD, may be on-boarded at the same time. The following Table 2 lists an information flow exchanged between the OSS/BSS and the NFVO.

TABLE 2

| Message | Requirement | Direction |
|---|---|---|
| OnboardNsdRequest | Mandatory | OSS/BSS−>NFVO |
| OnboardNsdResponse | Mandatory | NFVO−>OSS/BSS |

2. Input Parameters

The input parameters sent when invoking the on-board NSD operation may follow indications provided in Table 3.

TABLE 3

| Parameter | Qualifier | Cardinality | Content | Description |
|---|---|---|---|---|
| nsd | M | 1 | Nsd | NSD to be on-boarded |
| userDefinedData | O | 0~N | KeyValuePair | User defined data for NSD |

3. Output Parameters

The output parameters returned by the on-board NSD operation may follow indications provided in Table 4.

TABLE 4

| Parameter | Qualifier | Cardinality | Content | Description |
|---|---|---|---|---|
| nsdInfold | M | 1 | Identifier | Identifier of |
| | | | | on-boarded |
| | | | | instance of NSD |

4. On-Board NSD Operation Results

The result of the on-board NSD operation indicates whether on-boarding of the NSD is successful with a standard success/error result. The parameter ‘nsdInfoId’ is returned when the operation is successful.

<Enable NSD Operation>

1. Description

The Enable NSD operation may enable a previously disabled NSD instance and may instantiate a new network service with the Enable NSD. A sub-state “In use/Not in use” does not change as a result of the Enable NSD operation. Table 5 lists an information flow exchanged between the OSS/BSS and the NFVO.

TABLE 5

| Message | Requirement | Direction |
|---|---|---|
| EnableNsdRequest | Mandatory | OSS/BSS−>NFVO |
| EnableNsdResponse | Mandatory | NFVO−>OSS/BSS |

2. Input Parameters

The input parameters sent when invoking the Enable NSD operation may follow indications provided in Table 6.

TABLE 6

| Parameter | Qualifier | Cardinality | Content | Description |
|---|---|---|---|---|
| nsdInfoId | M | 1 | Identifier | Identifier of |
| | | | | on-boarded |
| | | | | instance of NSD |

3. Output Parameter

No output parameter.

4. Enable NSD Operation Result

The result of the Enable NSD operation indicates whether on-boarding of the NSD is successful with a standard success/error result. If the NSD is already enabled or is in a deletion pending state, the Enable NSD operation may return an error.

<Disable NSD operation>

1. Description

The Disable NSD operation may disable a previously enabled NSD instance and may prevent instantiation of a new network service with the disable NSD. The sub-state “In use/Not in use” does not change as a result of the Disable NSD operation. Table 7 lists an information flow exchanged between the OSS/BSS and the NFVO.

TABLE 7

| Message | Requirement | Direction |
|---|---|---|
| DisableNsdRequest | Mandatory | OSS/BSS−>NFVO |
| DisableNsdResponse | Mandatory | NFVO−>OSS/BSS |

2. Input Parameters

The input parameters sent when invoking the Disable NSD operation may follow indications provided in Table 8.

TABLE 8

| Parameter | Qualifier | Cardinality | Content | Description |
|---|---|---|---|---|
| nsdInfoId | M | 1 | Identifier | Identifier of |
| | | | | on-barcoded |
| | | | | instance of NSD |

3. Output Parameters

No output parameter.

4. Enable NSD Operation Result.

The result of the Disable NSD operation indicates whether it is successful with a standard success/error result. If the NSD is already disabled or is in a deletion pending state, the Disable NSD operation may return an error.

<Update NSD Operation>

1. description

The Update NSD operation may update an already on-boarded NSD and may create a new version of the NSD. The Update NSD operation may be used to update userDefinedData of an existing NsdInfo information element without creating the new version of the NSD. The previous versions of the NSDs are not modified.

It is possible to add or remove constituent descriptors (i.e., VNFDs, PNFDs, nested NSDs, VLDs, VNFFGDs, and Service Access Point Descriptors (SAPDs)) to or from an NSD via the Update NSD operation. This may be done by exchanging various descriptor references in the new NSD. For example, to add VNFDs to the NSD, the OSS/BSS adds corresponding VNFD identifiers to a list of vnfdIds in the new NSD. To remove VNFDs, the OSS/BSS does not include the vnfdIds (of the VNFDs to be removed) in the new NSD.

Table 9 lists an information flow exchanged between the OSS/BSS and the NFVO.

TABLE 9

| Message | Requirement | Direction |
|---|---|---|
| UpdateNsdRequest | Mandatory | OSS/BSS−>NFVO |
| UpdateNsdResponse | Mandatory | NFVO−>OSS/BSS |

2. Input Parameters

The input parameters sent when invoking the Update NSD operation may follow indications provided in Table 10.

TABLE 10

| Parameter | Qualifier | Cardinality | Content | Description |
|---|---|---|---|---|
| nsdInfoId | M | 1 | Identifier | Identifier of on-boarded version of |
| | | | | NSD |
| nsd | M | 0~1 | Nsd | New NSD to be created. Only |
| | | | | present if NSD itself is updated. |
| userDefined | O | 0~N | KeyValuePair | User defined data to be updated. |
| Data | | | | For existing keys, a value is |
| | | | | replaced. |

NOTE:
At least one of the two parameters is present. If nsd is not present, the Update NSD operation is used to update existing user defined data or add user defined data using the userDefinedData.

3. Output Parameters

The output parameters returned by the Update NSD operation follow indications provided in Table 11.

TABLE 11

| Parameter | Qualifier | Cardinality | Content | Description |
|---|---|---|---|---|
| nsdInfoId | M | 1 | Identifier | Identifier of |
| | | | | updated NSD |

4. Update NSD Operation Results

The result of the Update NSD operates indicates whether it is successful with a standard success/error result. The parameter “nsdlnfold” is returned when the nsdlnfold operation is successful. If the NSD is not already on-boarded or is in a deletion pending state, the Update NSD operation returns an error.

<Delete NSD Operation>

1. Description

The Delete NSD operation may delete one or more NSDs. It is possible to delete a single version or all of versions of an NSD. The NSD may be deleted when there is no instantiated NS. The NSD in a deletion pending list may no longer be enabled, disabled, or updated. It may be impossible to instantiate the NS(s) using the NSD in a deletion pending state. Table 12 lists an information flow exchanged between the OSS/BSS and the NFVO.

TABLE 12

| Message | Requirement | Direction |
|---|---|---|
| DeleteNsdRequest | Mandatory | OSS/BSS−>NFVO |
| DeleteNsdResponse | Mandatory | NFVO−>OSS/BSS |

2. Input Parameters

The input parameters sent when invoking the Delete NSD operation may follow indications provided in Table 13.

TABLE 13

| Parameter | Qualifier | Cardinality | Content | Description |
|---|---|---|---|---|
| nsdInfoId | M | 1 | Identifier | Identifier of on-boarded instance of |
| | | | | NSD to be deleted |
| applyOnAllVersions | O | 0~1 | Boolean | Indicates if Delete NSD operation is |
| | | | | to be applied on all versions of NSD. |
| | | | | By default, if not present, it applies |
| | | | | only on a current version. |

3. Output Parameters

The output parameters returned by the Delete NSD operation may follow indications provided in Table 14.

TABLE 14

| Parameter | Qualifier | Cardinality | Content | Description |
|---|---|---|---|---|
| deletedNsdInfoId | M | 1 | Identifier | Identifier of |
| | | | | deleted NSD |
| | | | | version |

4. Delete NSD Operation Results

The result of the Delete NSD operation indicates whether it is successful with a standard success/error result. If one of the NSDs is still in use or marked as delete pending, this is indicated as a part of the Delete NSD operation result and it will be deleted once all associated instantiated NSs are terminated.

<Query NSD Operation>

1. Description

The Query NSD operation may enable the OSS/BSS to query the NFVO concerning details of one or more NSDs. Table 15 lists an information flow exchanged between the OSS/BSS and the NFVO.

TABLE 15

| Message | Requirement | Direction |
|---|---|---|
| QueryNsdRequest | Mandatory | OSS/BSS−>NFVO |
| QueryNsdResponse | Mandatory | NFVO−>OSS/BSS |

2. Input Parameters

The input parameters sent when invoking the Query NSD operation may follow indications provided in Table 16.

TABLE 16

| Parameter | Qualifier | Cardinality | Content | Description |
|---|---|---|---|---|
| Filter | M | 1 | Filter | Filter that defines NSDs on which query |
| | | | | applies based on attributes of the NSDs. |
| | | | | Also, it can be used to specify one or more |
| | | | | NSDs to be queried by providing identifiers |
| | | | | thereof. |
| attributeSelector | M | 0~N | String | Provides list of attribute names of NSD. If |
| | | | | present, only attributes are returned for |
| | | | | instances of NSDs matching the filter. If |
| | | | | absent, complete NSD instances are returned. |

3. Output Parameters

The output parameters returned by the Delete NSD follow indications provided in Table 17.

TABLE 17

| Parameter | Qualifier | Cardinality | Content | Description |
|---|---|---|---|---|
| queryResult | M | 0~N | NsdInfo | Details of on-boarded |
| | | | | NSDs matching |
| | | | | an input filter |

4. Query NSD Operation Results

After the successful Query NSD operation, the NFVO may query internal NSD information objects. The result of the Query NSD operation indicates whether it is successful with a standard success/error result. For a specific query, information about NSDs that a consumer may access and that match the filter is returned.

<NSD State Model>

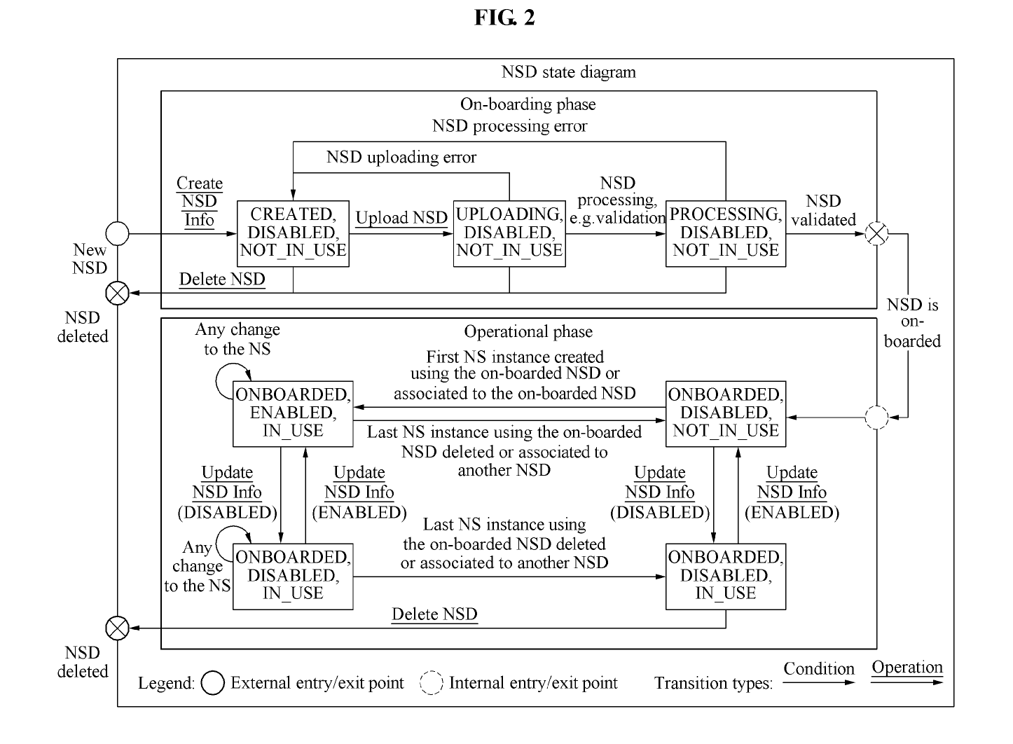

FIG. 2 illustrates an example of a transition of an NSD state model according to an example embodiment.

1. Introduction

A state model of an NSD in the NFVO is described. Here, an on-boarding phase of NSD and an operational phase of NSD are included as state models.

2. State model

A given NSD has three states, i.e., an on-boarding state, an operational state, and a usage state.

The on-boarding state is represented by the “nsdOnboardingState” attribute in the “NsdInfo” data type as follows:
CREATED: The NSD information object is created.
UPLOADING: The NSD is being uploaded.
PROCESSING: The NSD is being processed, e.g., validation.
ONBOARDED: The NSD is successfully on-boarded.

The operational state is represented by the “nsdOperationalState” attribute in the “NsdInfo” data type as follows:
ENABLED: The NSD is enabled.
DISABLED: The NSD is disabled.

The usage state is represented by the “nsdUsageState” attribute in the “NsdInfo” data type as follows:
IN_USE: The NSD is in use.
NO_IN_USE: The NSD is not in use.

The state model of the on-board phase of FIG. 2 is applied to the given NSD. In addition to operations and conditions specified in FIG. 2, the following operations are also considered as available during the on-boarding phase;
Query NSD Info
Update NSD Info (with user defined data only)

The state model of the operational phase shown in FIG. 2 is applied to an on-boarded NSD. In addition to the operations and conditions specified in FIG. 2, the following operations are also considered as available during the operational phase.
Query NSD Info
Update NSD Info (with user defined data only)
Fetch NSD

At the end of the on-boarding phase, the “nsdOnboardingState” value transitions to “ONBOARDED”, the “nsdOperationalState” value transitions from “DISABLED” to “ENABLED”, and the operational phase is entered.

“nsdOperationalState” and “nsdUsageState” describe in detail the state changes during the NSD operational phase. During the NSD on-boarding phase, the value of “nsdOperationalState” is “DISABLED” and the value of “nsdUsageState” is “NOT-IN_USE”. After the NSD is on-boarded, the value of “nsdOperationalState” is changed to “ENABLED” and the value of “nsdUsageState” is maintained as “NOT_IN_USE”.

<URI Structure and Supported Content Formats>

Herein, URI prefix and the supported formats applicable to APIs are described. All resource URIs of APIs may have the following prefix:

{apiRoot}/{apiName}/{apiVersion}

Here, {apiRoot} indicates a scheme (“http” or “https”), a host name and optional port, and an optional prefix path. {apiName} indicates an interface name in an abbreviated form. {apiVersion} indicates a current API version.

For HTTP requests and responses that have a body, the content format JSON is supported. The JSON format is signaled by the content type “application/j son”.

All APIs support and use the HTTP over TLS. All resource URIs of the API comply with the URI syntax. An implementation that dynamically generates resource URI parts (path segments, query parameter values) may ensure that the parts only use a character set that is allowed by IETF RFC 3986 [10].

<NSD Management Interface>

The NSD management interface allows the OSS/BSS to invoke management operations of NSDs toward the NFVO and to subscribe to notifications related to NSD management changes. The following operations are provided through the NSD management interface:
Create NSD Info
Upload NSD
Fetch NSD
Update NSD Info
Delete NSD
Query NSD Info
Create PNFD Info
Upload PNFD
Fetch PNFD
Update PNFD Info
Delete PNFD
Query PNFD Info
Subscribe
Terminate Subscription
Query Subscription Information
Notify

<Resource Structure and Methods>

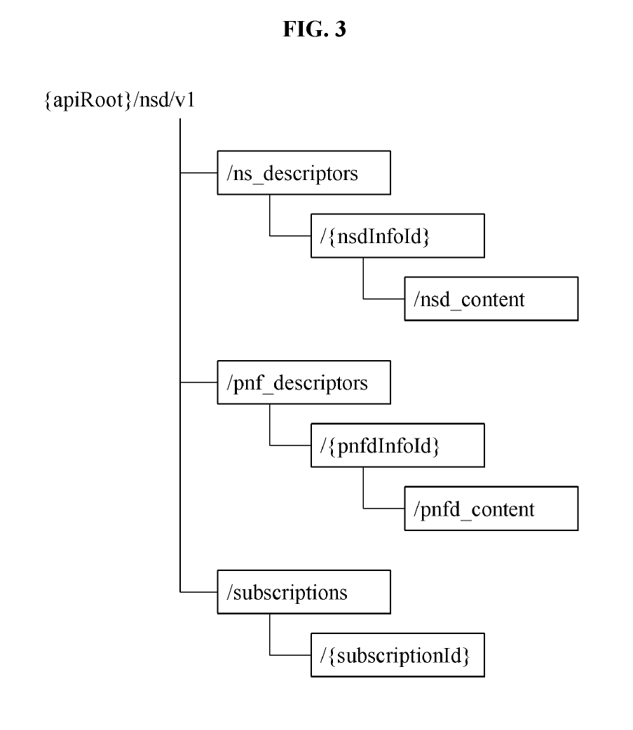

FIG. 3 illustrates a resource URI structure of an NSD management interface according to an example embodiment.

All resource URIs of the API use base URI specification. The string “nsd” is used to represent {apiName}. {apiVersion} is set as “v1”. All resource URIs are defined relative to the base URI. FIG. 3 illustrates the overall resource URI structure defined for the NSD management interface.

Here, /ns_descriptors represent NS Descriptors including only VNF, and /{nsdInfoId} represents a single NS descriptor including only VNF. Also, /pnf_descriptors represent PNF descriptors included in the NS, and /{pnfdInfoId} represents a single PNF Descriptor included in the NS. /subscriptions indicates registration for receiving alarm information of the associated NSD, and /{subscriptionld} indicates a single registration identifier.

Table 18 lists the defined individual resources and applicable HTTP methods. The NFVO supports responding to requests for all HTTP methods.

TABLE 18

| Resource | | HTTP | | |
|---|---|---|---|---|
| name | Resource URI | Method | Cat | Meaning |
| NS | /ns_descriptors | GET | M | Query information about multiple NS |
| Descriptors | | | | descriptor resources. |
| | | POST | M | Create new NS descriptor resource. |
| Individual | /ns_descriptors/ | GET | M | Read information about individual NS |
| NS | {nsdInfoId} | | | descriptor resource. |
| Descriptor | | PATCH | M | Modify operational state and/or user defined |
| | | | | data of individual NS descriptor resource. |
| | | DELETE | M | Delete individual NS descriptor resource. |
| NSD Content | /ns_descriptors/ | GET | M | Fetch content of NSD. |
| | {nsdInfoId}/ | PUT | M | Upload content of NSD. |
| | nsd_content | | | |
| PNF | /pnf_descriptors | GET | M | Query information about multiple PNF |
| Descriptors | | | | descriptor resources. |
| | | POST | M | Create new PNF descriptor resource. |
| Individual | /pnf_descriptors/ | GET | M | Read individual PNFD resource. |
| PNF | {pnfdInfoId} | PATCH | M | Modify user defined data of individual PNF |
| Descriptors | | | | descriptor resource. |
| | | DELETE | M | Delete individual PNF descriptor resource. |
| Subscriptions | /subscriptions | POST | | Subscribe to NSD and PNFD change |
| | | | | notifications. |
| | | GET | | Query multiple subscriptions. |
| Individual | /subscriptions/ | GET | M | Read individual subscription resource. |
| subscription | {subscriptionId} | DELETE | M | Terminate subscription. |

<Flow of Creation of Individual NS Descriptor Resource>

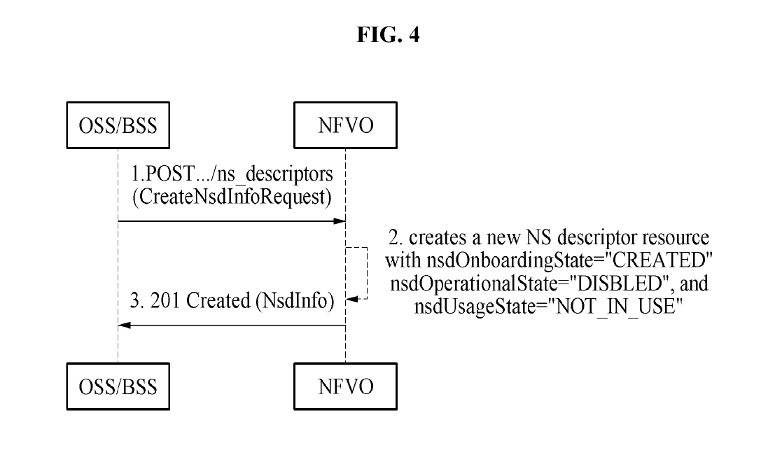

FIG. 4 illustrates a procedure of creating an individual NS descriptor resource according to an example embodiment.

Referring to FIG. 4, the OSS/BSS sends a POST request to the “ns_descriptors” resource that includes a data structure of type “CreateNsdInfoRequest” in a payload body.

The NFVO creates a new NS descriptor resource with nsdOnboardingState=“CREATED”, nsdOperationalState=“DISABLED”, and nsdUsageState=“NOT_IN_USE”.

The NFVO returns a 201 Created response that contains a representation of the individual NS descriptor resource created by the NFVO.

Once the procedure is successfully completed, the individual NS descriptor resource is created with nsdOnboardingState=“CREATED”, nsdOperationalState=“DISABLED”, and nsdUsageState=“NOT_IN_USE”.

<Flow of Uploading of NSD Content>

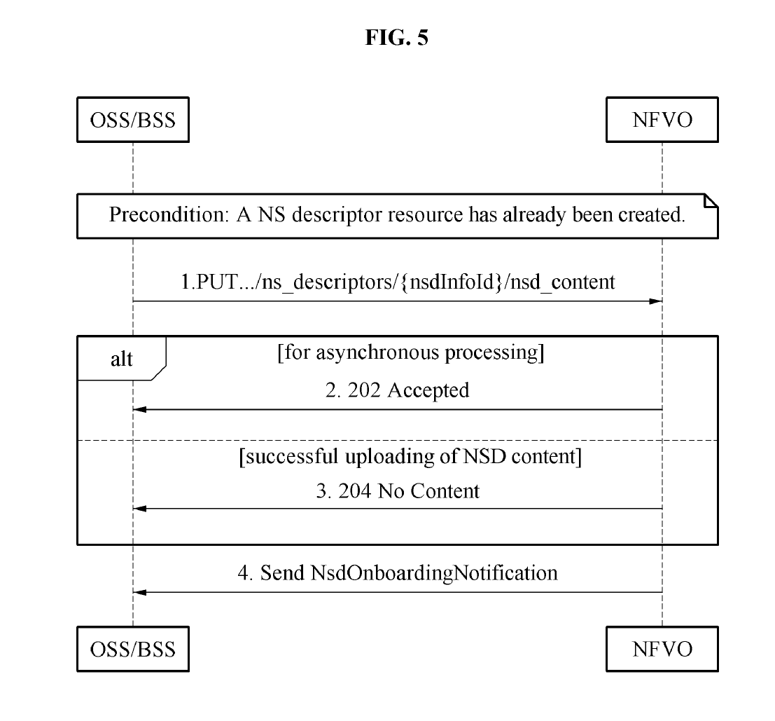

FIG. 5 illustrates a procedure of uploading of NSD content according to an example embodiment.

As a precondition, an NS descriptor resource is already created. The OSS/BSS sends a PUT request to an “NSD Content” resource using a “Content-Type” HTTP header.

For asynchronous processing, the NFVO returns “202 Accepted”. Otherwise, the NFVO returns a “204 No Content” response to the OSS/BSS with an empty payload body for successful uploading of the NSD content.

The NFVO sends NsdOnboardingNotification to the OSS/BSS. Due to possible race conditions, “204 No Content” and “NsdOnBoardingNotification” may arrive at the OSS/BSS in random order.

In the case of failure, appropriate error information is provided in a response.

<Flow of Fetching of NSD Content>

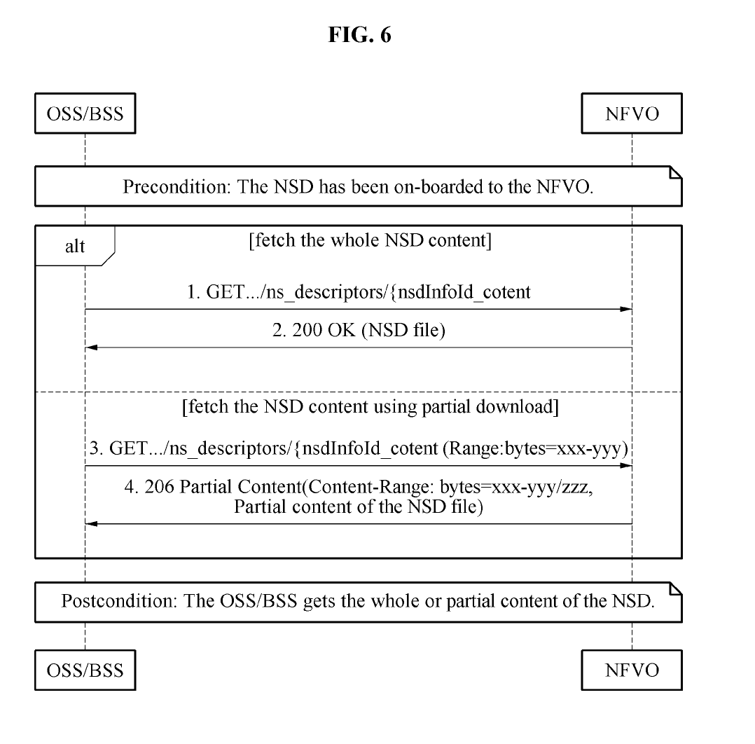

FIG. 6 illustrates a procedure of fetching on-boarded NSD content.

As a precondition, an NSD is on-boarded to the NFVO. In the case of fetching the whole NSD content, the OSS/BSS sends a GET request to the “NSD content” resource. The NFVO returns a “200 OK” response and includes a copy of an NSD file in a payload body.

In the case of fetching the NSD content using partial download, the OSS/BSS sends a GET request to the “NSD content” resource and includes a “Range” HTTP header indicating a partition of the NSD content that needs to be transferred. The NFVO returns a “206 Partial Content” response with a payload body containing the partial content of the NSD and a “Content-Range” HTTP header indicating the byte range including the payload and the complete length of the NSD.

If the procedure is successfully completed, the OSS/BSS may obtain the whole or partial content of the NSD. If the procedure fails, appropriate error information is provided in a response.

<Flow of Update of Individual NS Descriptor Resource>

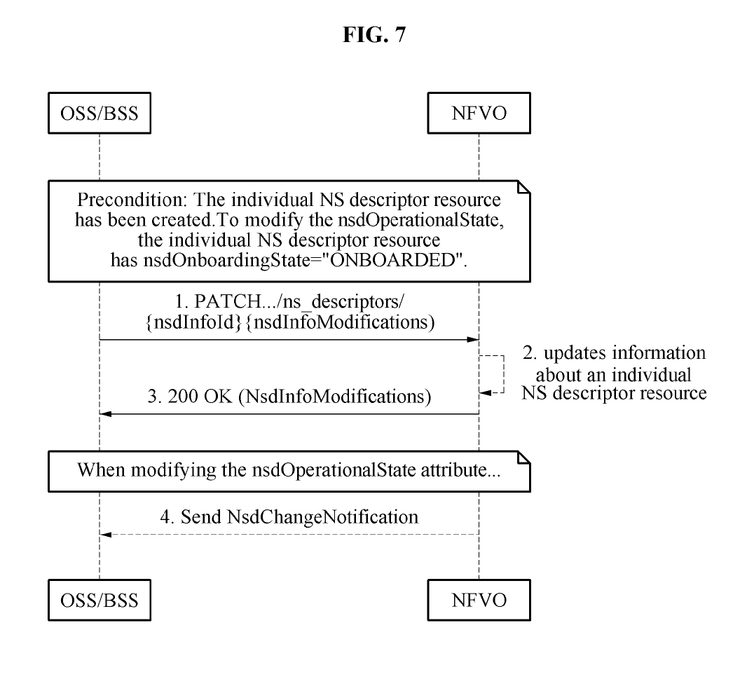

FIG. 7 illustrates an example of a procedure of updating an NS descriptor resource according to an example embodiment. The Update NSD Info operation may modify an operational state of the individual NS descriptor resource and/or user defined data.

As a precondition, the individual NS descriptor resource is created. To modify nsdOperationalState from “ENABLED” to “DISABLED” or vice-versa, the individual NS descriptor resource has nsdOnboardingState=“ONBOARDED”.

The OSS/BSS sends a PATCH request to the “Individual NS descriptor” resource.

The NFVO modifies information about the individual NS descriptor resource.

The NFVO returns a “200 OK” response including the data structure of type “nsdInfoModifications” in a payload body.

When modifying the nsdOperationalState attribute, the NFVO sends, to the OSS/BSS, an NsdChangeNotification to indicate the state change of the individual NS descriptor resource.

If the procedure is successfully completed, information about the individual NS descriptor resource is updated. Also, due to possible race conditions, the “200 OK” response and the NsdChangeNotification may arrive at the OSS/BSS in random order.

<Flow of Deletion of Individual NS Descriptor Resource>

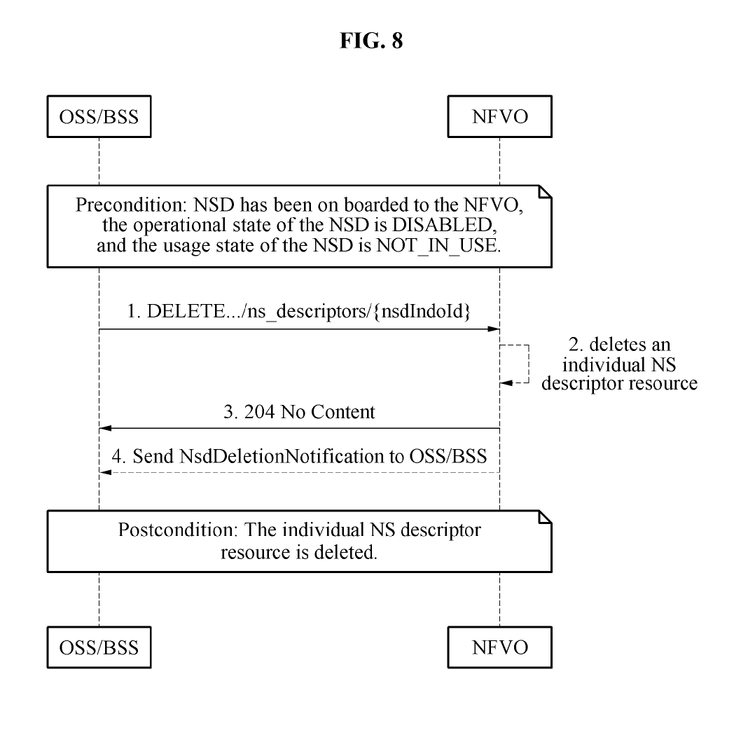

FIG. 8 illustrates a procedure for deleting an individual NS descriptor resource according to an example embodiment. As precondition, the NSD resource may be on-boarded to the NFVO, the operational state of the NSD may be “DISABLED”, and the usage state of the NSD may be “NOT_IN_USE”.

The OSS/BSS sends a DELETE request to the “Individual NS descriptor” resource.

The NFVO deletes the individual NS descriptor resource.

The NFVO returns a “204 No Content” response to the OSS/BSS with an empty payload body.

The NFVO sends, to the OSS/BSS, NsdDeletionNotification to indicate the deletion of the individual NS descriptor resource.

Due to possible race conditions, the “204 No Content” response and NsdDeletionNotification may arrive at the OSS/BSS in random order.

<Flow of Querying/Reading of NS Descriptor Resource>

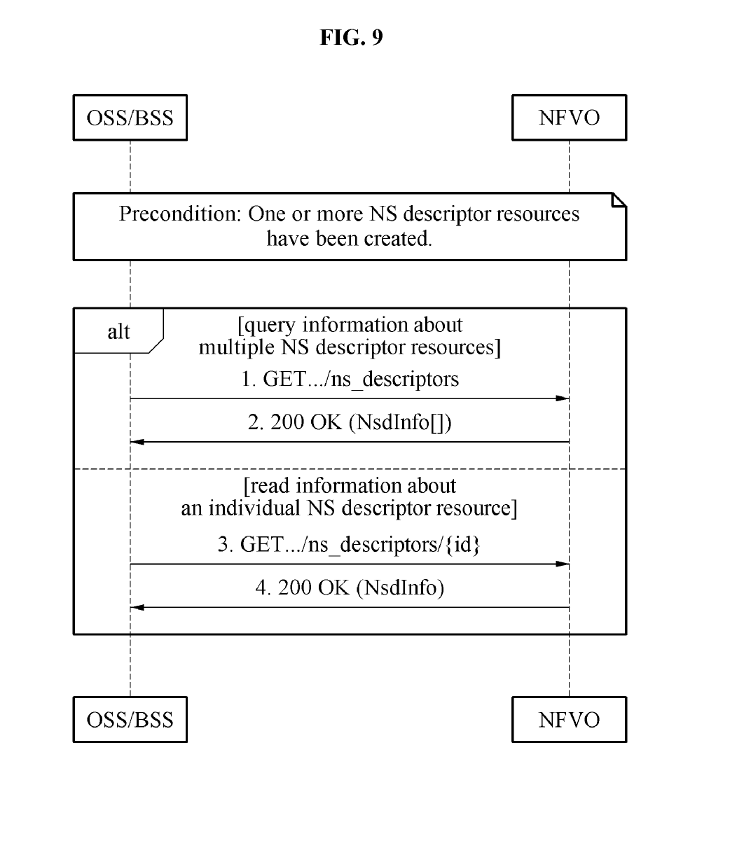

FIG. 9 illustrates an example of a procedure of querying information about multiple NS descriptor resources and reading information of an individual NS descriptor resource according to an example embodiment. As a precondition, one or more NS descriptor resources are created.

If the OSS/BSS intends to query information about multiple NS descriptor resources, the OSS/BSS sends a GET request to the ns_descriptors resource. The NFVO returns a “200 OK” response and includes zero or more data structures of type “NsdInfo” in a payload body.

If the OSS/BSS intends to read information about an individual NS descriptor resource, the OSS/BSS sends a GET request to the “Individual NS descriptor” resource that is addressed by an appropriate NsdInfo identifier in its resource URI. The NFVO returns a “200 OK” response and includes a data structure of type “NsdInfo” in a payload body.

If the procedure is successfully completed, the OSS/BSS may obtain information about zero or more NS descriptor resources or information about the individual NS descriptor resource. If the procedure fails, appropriate error information is provided in a response.

<Resource: Ns Descriptors>

When the resource represents NS descriptors, a client may use the resource to create an individual NS descriptor and may query the NS descriptor.

The resource URI: {apiRoot}/nsd/n1/ns_descriptors

(1) If the resource method is POST:

The POST method is used to create a new NS descriptor resource or a new version of an on-boarded NS descriptor resource. The POST method follows provisions specified in the following Tables 19 and 20 for URI query parameters, request and response data structures, and response codes. Table 19 shows URI query parameters supported by the POST method. Table 20 shows details of the POST response/response.

TABLE 19

| | | |
|---|---|---|
| Name | Cardinality | Description |

none supported

TABLE 20

| | Data type | Cardinality | Description | |
|---|---|---|---|---|
| Request | CreateNsdInfoRequest | 1 | Parameters of creating NS descriptor resource | |
| body | | | | |
| | | | Response | |
| | Data type | Cardinality | Codes | Description |
| Response | NsdInfo | 1 | 201 | NS descriptor creator was successfully |
| body | | | Created | created as new NS descriptor resource. |
| | | | | Response body includes representations |
| | | | | of the new NS descriptor resource. |
| | | | | HTTP response includes “Location” |
| | | | | HTTP header that contains resource URI |
| | | | | of the new NS descriptor resource. |

(2) if the Resource Method is GET:

The GET method queries information about multiple NS descriptor resources. The GET method follows provisions specified in the following Tables 21 and 22. Table 21 shows query parameters supported by the GET method. Table 22 shows details of the GET request/response.

TABLE 21

| Name | Cardinality | Description |
|---|---|---|
| (filter) | 0~1 | Attribute-based filtering parameters. |
| | | NFVO supports receiving filter parameters as |
| | | part of URI query string. OSS/BSS may supply |
| | | filtering parameters. |
| | | All attribute names that appear in NsdInfo |
| | | and in data types referenced thereform are |
| | | supported in attribute-based filtering |
| | | parameters. |
| all_fields | 0~1 | Include all complex attributes in response. |
| Fields 0~1 | 0~1 | Complex attributes to be included in response. |

TABLE 22

| | Data type | Cardinality | Description | |
|---|---|---|---|---|
| Request | n/a | | | |
| body | | | | |
| | | | Response | |
| | Data type | Cardinality | Codes | Description |
| Response | NsdInfo | 0~N | 200 OK | Information about zero or more NS |
| body | | | | descriptors. |
| | | | | Response body includes |
| | | | | representation of zero or more NS |
| | | | | descriptors. |
| | ProblemDetails | 1 | 400 Bad | Response body |
| | | | Request | containsProblemDetails structure in |
| | | | | which “detail” attribute conveys |
| | | | | more information about error. |
| | ProblemDetails | 1 | 400 Bad | Response body contains |
| | | | Request | ProblemDetails structure in which |
| | | | | “detail” attribute conveys more |
| | | | | information about error. |

(3) If the method is PUT:

The PUT method is not supported. When the PUT method is requested on this resource, the NFVO returns a “405 Method Not Allowed” response.

(4) If the resource method is PATCH:

The PATCH method is not supported. When the PATCH method is requested on this resource, the NFVO returns the “405 Method Not Allowed” response.

(5) If the resource method is DELETE:

The DELETE method is not supported. When the DELETE method is requested on this resource, the NFVO returns the “405 Method Not Allowed” response.

<Resource: Individual NS Descriptor>

When the resource represents an individual NS descriptor, a client may use this resource to modify, delete, and read information of the individual NS descriptor.

The resource URI: {apiRoot}/nsd/n1/ns_descriptors/{nsdInfoID}

(1) If the resource method is POST:

The POST method is not supported. When the POST method is requested on this resource, the NFVO returns a “405 Method Not Allowed” response.

(2) If the resource method is GET:

The GET method reads information about an individual NS descriptor. The GET method follows provisions specified in the following Tables 23 and 24 for URI query parameters, request and response data structures, and response codes. Table 23 shows URI query parameters supported by the GET method. Table 24 shows details of the GET request/response.

TABLE 23

| | | |
|---|---|---|
| Name | Cardinality | Description |

None supported

TABLE 24

| | Data type | Cardinality | Description | |
|---|---|---|---|---|
| Request | n/a | | | |
| body | | | | |
| | | | Response | |
| | Data type | Cardinality | Codes | Description |
| Response | NsdInfo | 1 | 200 OK | Information about individual NS |
| body | | | | descriptor. |
| | | | | Response body contains representation of |
| | | | | individual NS descriptor. |

(3) If the resource method is PUT:

The PUT method is not supported. When the PUT method is requested on this resource, the NFVO returns a “405 Method Not Allowed” response.

(4) If the resource method is PATCH:

The PATCH method modifies the operational state and/or user defined data of an individual NS descriptor resource.

The PATCH method may be used to enable a previously disabled NS descriptor resource, allowing again its use for instantiation of a new network service with this NS descriptor.

The PATCH method may be used to disable the previously enabled NS descriptor resource, preventing any further use for instantiation of new network service(s) with this NS descriptor. The usage state (i.e., “IN_USE”/“NOT_IN_USE”) does not change.

The PATCH method may be used to modify the user defined data of the individual NS descriptor resource.

The PATCH method follows provisions specified in the following Tables 25 and 26 for URI query parameters, request and response data structures, and response codes.

TABLE 25

| | | |
|---|---|---|
| Name | Cardinality | Description |

None supported

TABLE 26

| | Data type | Cardinality | Description | |
|---|---|---|---|---|
| Request | NsdInfoModifications | 1 | Parameters for modification of individual NS | |
| body | | | descriptor resource. | |
| | | | Response | |
| | Data type | Cardinality | Codes | Description |
| Response | NsdInfoModifications | 1 | 200 OK | Operation is successfully |
| body | | | | completed. |
| | | | | Response body contains attribute |
| | | | | modifications for individual NS |
| | | | | descriptor resource. |

(5) If the resource method is DELETE:

The DELETE method deletes an individual NS descriptor resource. The individual NS descriptor resource may be deleted when no NS instance using the same is absent or is already disabled. Otherwise, the DELETE method may fail. The DELETE method follows provisions specified in the following Tables 27 and 28 for URI query parameters, request and response data structures, and response codes. Table 27 shows URI query parameters supported by the DELETE method. Table 28 shows details of the DELETE request/response.

TABLE 27

| | | |
|---|---|---|
| Name | Cardinality | Description |

None supported

TABLE 28

| | Data type | Cardinality | Description | |
|---|---|---|---|---|
| Request | n/a | | | |
| body | | | | |
| | | | Response | |
| | Data type | Cardinality | Codes | Description |
| Response | n/a | | 204 No | Operation is successfully completed. |
| body | | | Content | Response body may be empty. |

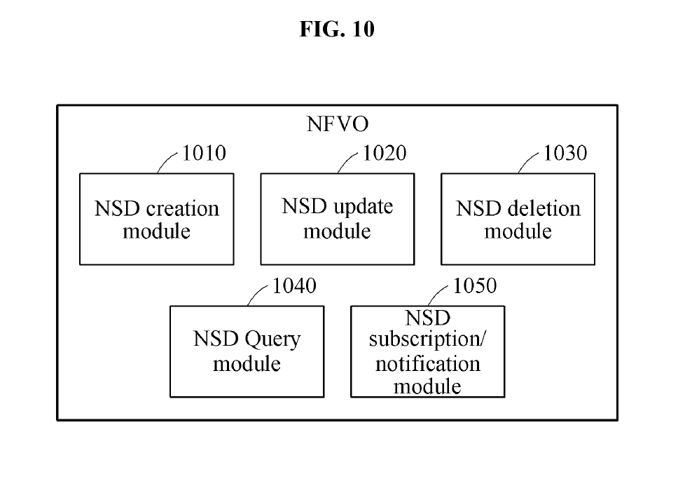

FIG. 10 is a diagram illustrating an example of a module included in an NFVO for supporting NSD management according to an example embodiment.

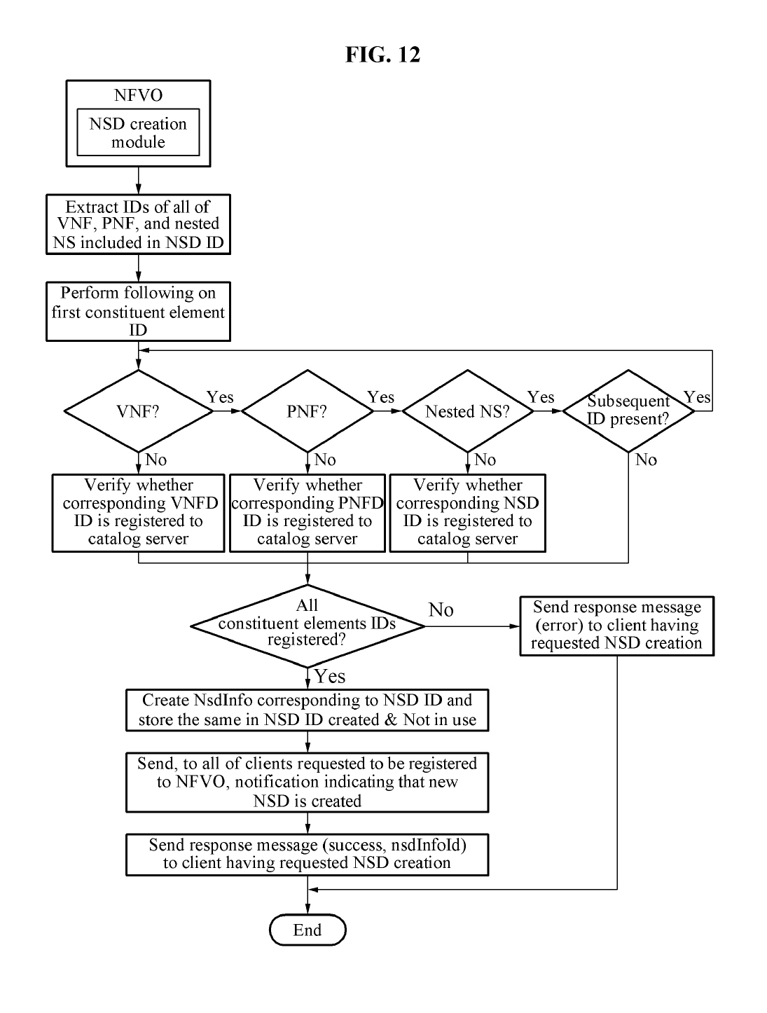

Referring to FIG. 10, an NSD creation module 1010 is a module configured to perform NSD creation, an NSD update module 1020 is a module configured to perform NSD modification or update, an NSD deletion module 1030 is a module configured to perform NSD deletion, an NSD query module 1040 is a module configured to perform NSD search or query, and an NSD subscription/notification module 1050 is a module configured to perform NSD registration request or notification. Hereinafter, an operation of each module will be described with reference to FIGS. 12 through 16. Alternatively, each module may be executed by a processor embedded in the NFVO.

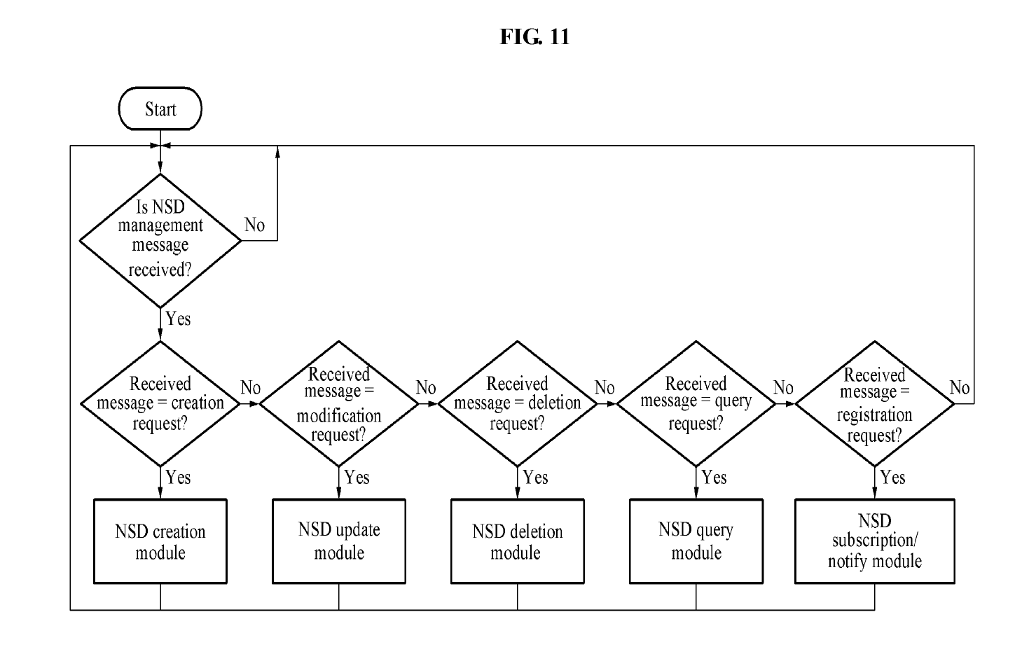

FIG. 11 is a flowchart illustrating a process of processing an NSD management module in an NFVO according to an example embodiment.

In response to receiving an NSD management message, the NFVO determines whether the management message is an NSD creation request. In response to the management request being determined as the NSD creation request, the NSD is created by the NSD creation module. A detailed process will be described with reference to FIG. 12.

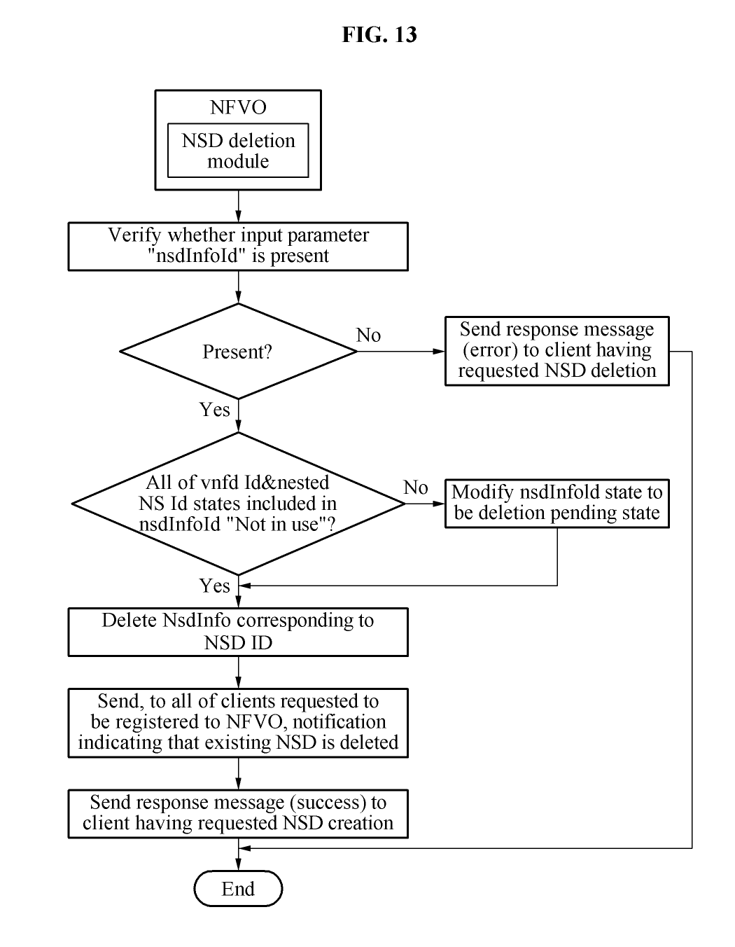

In response to receiving the NSD management message, the NFVO determines whether the management message is the NSD creation request or an NSD modification and/or update request. In response to the management request being determined as the NSD modification and/or update request, the NSD is modified and/or updated by the NSD update module. A detailed process will be described with reference to FIG. 13.

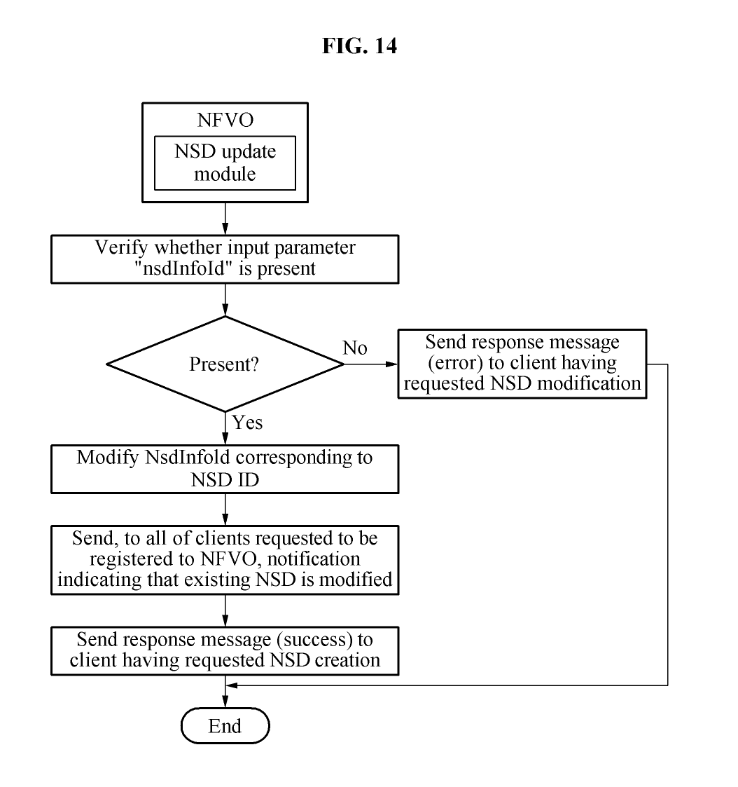

In response to receiving the NSD management message, the NFVO determines whether the management message is the NSD modification and/or update request or an NSD deletion request. In response to the management request being determined as the NSD deletion request, the NSD is deleted by the NSD deletion module. A detailed process will be described with reference to FIG. 14.

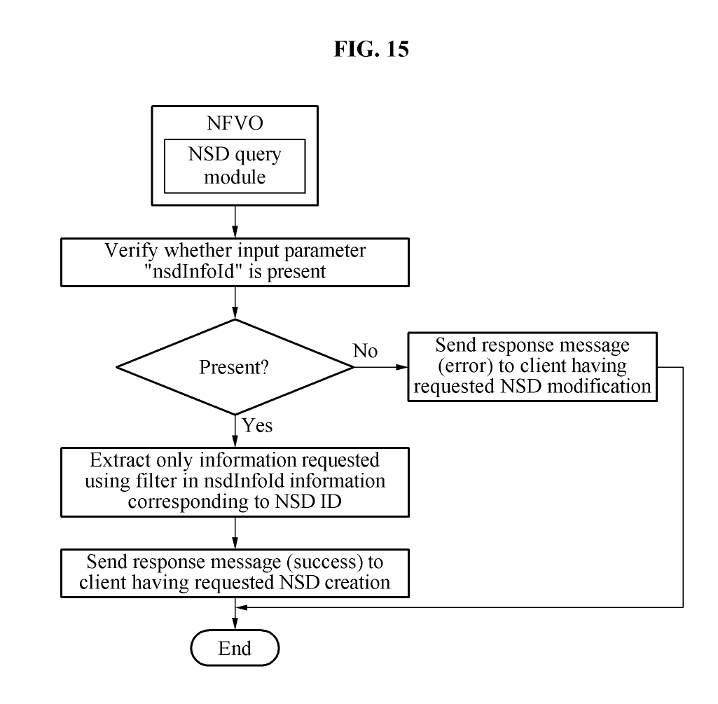

In response to receiving the NSD management message, the NFVO determines whether the management message is the NSD deletion request or an NSD retrieval and/or query request. In response to the management request being determined as the NSD query and/or query request, the NSD is retrieved and/or queried by the NSD query module. A detailed process will be described with reference to FIG. 15.

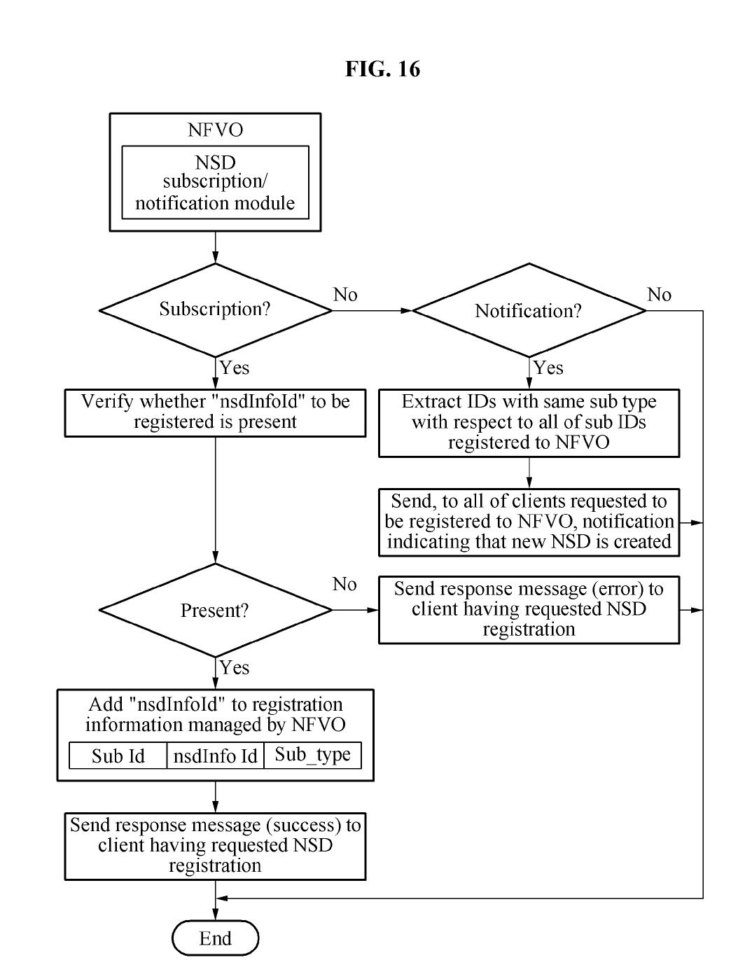

In response to receiving the NSD management message, the NFVO determines whether the management message is the NSD retrieval and/or query request or an NSD registration request. In response to the management request being determined as the NSD registration request, the NSD is registered by the NSD subscription/notification module. A detailed process will be described with reference to FIG. 16.

FIG. 12 is a flowchart illustrating a process of performing, by an NFVO, an NSD creation according to an example embodiment.

An NSD creation module included in the NFVO may perform the NSD creation. The NSD creation module may extract IDs of all of a VNF, a PNF, and a nested NS include in NSD ID.

(a) The NSD creation module may verify whether a first constituent element ID is a VNF. If ID=VNF, the NSD creation module may verify whether a corresponding VNFD ID is registered to a catalog server.

(b) The NSD creation module may verify whether the first constituent element ID is not the VNF but a PNF. If ID=PNF, the NSD creation module may verify whether a corresponding PNFD ID is registered to the catalog server.

(c) The NSD creation module may verify whether the first constituent element ID is not the PNF but a nested NS. If ID=nested NS, the NSD creation module may verify whether a corresponding NSD ID is registered to the catalog server.

If the first constituent element ID is not nested NS and a subsequent constituent element ID is present, the NSD creation module may repeat the same process of (a) to (c) with respect to the subsequent constituent element ID. If the subsequent constituent element ID is absent, the NSD creation module may verify whether all of the constituent elements IDs are registered.

If all of the constituent elements IDs are verified to be registered to the catalog server, the NSD creation module may create NsdInfo corresponding to the NSD ID and may store the same in a state “NSD ID created & Not in use”. Here, the NSD creation module may send, to all of the clients requested to be registered to the NFVO, a notification indicating that the new NSD is created, and may send a response message, for example, success and nsdInfoId, to a client having requested the NSD creation.

If all of the constituent elements IDs are verified to not be registered to the catalog server, the NSD creation module may send a response message, for example, an error, to the client having requested the NSD creation.

FIG. 13 is a flowchart illustrating a process of performing, by an NFVO, an NSD deletion according to an example embodiment.

An NSD deletion module included in the NFVO may perform the NSD deletion. The NSD deletion module may verify whether an input parameter “nsdInfoId” is present. In response to absence of the input parameter “nsdInfoId”, the NSD deletion module may send a response message, for example, an error, to a client having requested the NSD deletion.

In response to presence of the input parameter “nsdInfoId”, the NSD deletion module may verify whether all of vnfd Id&nested NS Id states included in nsdInfoId correspond to state “Not in use”. If not, the NSD deletion module may modify the nsdInfoId state to be a deletion pending state.

If all of the vnfd Id&nested NS ID states are verified to be Not in use, the NSD deletion module may delete NsdInfo corresponding to the NSD ID and may send, to all of the clients requested to be registered to the NFVO, a notification indicating that the existing NSD is deleted. The NSD deletion module may send a response message, for example, a success, to the client having requested the NSD creation.

FIG. 14 is a flowchart illustrating a process of performing, by an NFVO, an NSD update according to an example embodiment.

An NSD update module included in the NFVO may perform the NSD update. The NSD update module may verify whether an input parameter “nsdInfoId” is present. In response to absence of the input parameter “nsdInfoId”, the NSD update module may send a response message, for example, an error, to a client having requested an NSD modification.

In response to presence of the input parameter “nsdInfoId”, the NSD update module may modify nsdInfoId information corresponding to the NSD ID. The NSD update module may send, to all of the clients requested to be registered to the NFVO, a notification indicating that the existing NSD is modified and/or updated. The NSD update module may send a response message, for example, a success, to the client having requested the NSD creation.

FIG. 15 is a flowchart illustrating a process of performing, by an NFVO, an NSD query according to an example embodiment.

An NSD query module included in the NFVO may perform the NSD query. The NSD query module may verify whether the input parameter “nsdInfoId” is present. In response to absence of the input parameter “nsdInfoId”, the NSD query module may send a response message, for example, an error to a client having requested an NSD modification.

In response to presence of the input parameter “nsdInfoId”, the NSD query module may extract only information requested using a filter in nsdInfoId information corresponding to the NSD ID. The NSD query module may send a response message, for example, a success, to a client having requested the NSD creation.

FIG. 16 is a flowchart illustrating a process of performing, by an NFVO, an NSD subscription/notification according to an example embodiment.

An NSD subscription/notification module included in the NFVO may perform a subscription or a notification. The NSD subscription/notification nodule may verify whether of subscription. In the case of the subscription, the NSD subscription notification module may verify whether “nsdInfoId” to be registered is present.

In response to absence of “nsdInfoId”, the NSD subscription/notification module may send a response message, for example, an error, to a client having requested the NSD registration. Alternatively, in response to presence of “nsdInfoId”, the NSD subscription/notification module may add “nsdInfoId” to registration information managed by the NFVO as shown in Table 25. The NSD subscription/notification module may send a response message, for example, a success, to the client having requested the NSD registration.

TABLE 29

| | | |
|---|---|---|
| Sub Id | nsdInfold | Sub_type |

The NSD subscription/notification module may verify whether a corresponding reception is subscription or notification. In response to the corresponding reception being determined as the notification, the NSD subscription/notification module may extract the IDs with the same sub type with respect to all of sub IDs registered to the NFVO. The NSD subscription/notification module may send, to all of the clients requested to be registered to the NFVO, a notification indicating that the new NSD is created.

The units and/or modules described herein may be implemented using hardware components, software components, and/or combination thereof. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include plurality of processing elements and plurality of types of processing elements. For example, a processing device may include plurality of processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A Network Service (NS) descriptor management method performed by a Network Functions Virtualization Orchestrator (NFVO), the method comprising:
receiving a request message for a Hypertext Transfer Protocol (HTTP) method for an NS descriptor from an Operation Support System/Business Support System (OSS/BSS); and
responding to the OSS/BSS with respect to the received request message,
wherein, if the HTTP method for the NS descriptor is POST, a new NS descriptor is created, and if the HTTP method for the NS descriptor is GET, query information about a plurality of network descriptors is processed.

2. The method of claim 1, wherein, in the created NS descriptor, NSDOperationalState is set as “DISABLED”, NSDUsageState is set as “NOT_IN_USE”, and NSDOnboardingState is set as “CREATED”.

3. A method of managing each Network Service (NS) descriptor, performed by a Network Functions Virtualization Orchestrator (NFVO), the method comprising:
receiving a request message for a Hypertext Transfer Protocol (HTTP) method for each NS descriptor from an Operation Support System/Business Support System (OSS/BSS); and
responding to the OSS/BSS with respect to the received request message,
wherein, if the HTTP method for each NS descriptor is GET, information about each NS descriptor is read, if the HTTP method for each NS descriptor is PATCH, information about each network descriptor is modified, and if the HTTP method for each NS descriptor is DELETE, each NS descriptor is deleted.

4. The method of claim 3, wherein, in the created NS descriptor, NSDOperationalState is set as “DISABLED”, NSDUsageState is set as “NOT_IN_USE”, and NSDOnboardingState is set as “CREATED”.

5. A Network Service (NS) descriptor management method performed by a Network Functions Virtualization Orchestrator (NFVO), the method comprising:
receiving a POST request message from an Operation Support System/Business Support System (OSS/BSS);
creating an NS descriptor in response to the received POST request message; and
sending, to the OSS/BSS, a response message indicating that the NS descriptor is created.

6. The method of claim 5, wherein, in the created NS descriptor, NSDOperationalState is set as “DISABLED, NSDUsageState is set as “NOT_IN_USE”, and SDOnboardingState is set as “CREATED”.

7. The method of claim 5, wherein the POST request message includes a data structure of “CreateNsdInfoRequest” in a payload.
